(19) United States
(12) Patent Application Publication
(10) Pub. No.: US 2011/0078007 A1
(43) Pub. Date: Mar. 31, 2011

(54) REAL-TIME AND LOCALIZED MATCHING METHOD, PLATFORM AND SYSTEM FOR GROUP PURCHASE

(75) Inventors: Li-Der CHOU, Taoyuan County (TW); Yu-Hong LIN, Kaohsiung City (TW); Bo-Teng DENG, Taoyuan County (TW)

(73) Assignee: NATIONAL CENTRAL UNIVERSITY, TAOYUAN COUNTY (TW)

(21) Appl. No.: 12/786,029

(22) Filed: May 24, 2010

(30) Foreign Application Priority Data
Sep. 30, 2009 (TW) 98133215

(51) Int. Cl. G06Q 30/00; G06Q 10/00; G01S 19/42; G06F 17/30

(52) U.S. Cl. 705/14.23; 342/357.25; 707/812; 707/E17.009

(57) ABSTRACT

A real-time and localized matching method for group purchase includes the following steps: a group purchase database, which stores information of several present group purchase activities, is provided. A present position of a client is received. Nearby group purchase activities held near the client are sifted from the present group purchase activities and provided to the client. A selection message, which includes information of a group purchase activity selected from the nearby group purchase, is received from the client. The client's shopping list for the selected group purchase activity is obtained from the client to register the client's shopping list to the shopping list of the selected group purchase activity in the group purchase database. The contact information of the selected group purchase activity is transmitted to the client if the registered shopping list of the selected group purchase activity satisfies the discount condition of the selected group purchase activity.

### RELATED APPLICATIONS

This application claims priority to Taiwan Application Serial Number 98133215, filed Sep. 30, 2009, which is herein incorporated by reference.

### BACKGROUND

1. Technical Field

The present invention relates to a matching method, platform and system. More particularly, the present invention relates to a real-time and localized matching method, platform and system for group purchase.

2. Description of Related Art

Nowadays, department stores or shopping malls often provide many different discount activities to attract consumers. Besides, many consumers are enthusiastic about the discount activities for saving money. Wherein, rebate for every fixed amount, discount for every fixed amount, free shipping rate with a target amount, gift with a target amount are the most popular discount activities.

Vendors often set minimal purchase threshold for joining discount activities. However, some consumers just want to buy a few goods, which is hard to satisfy discount conditions for joining discount activities. Hence, consumers may leave without buying anything. In addition, some other consumers may buy unneeded goods to satisfy discount conditions, which makes consumer spend more unexpected money.

### SUMMARY

According to one embodiment of this invention, a real-time and localized matching method for group purchase is provided. The steps of the real-time and localized matching method for group purchase executed by a real-time and localized matching platform for group purchase includes: a group purchase database is provided. The group purchase database stores information of several present group purchase activities. The information of the present group purchase activities includes positions, discount conditions, shopping lists and contact information of the present group purchase activities. A present position of a client is received. Several nearby group purchase activities held near the present position of the client are sifted from the present group purchase activities according to the positions of the present group purchase activities. The nearby group purchase activities to the client are provided to the client. A selection message is received from the client. The selection message includes information of a selected group purchase activity selected from the nearby group purchase activities. The client's shopping list for the selected group purchase activity is obtained from the client. The client's shopping list is registered to the shopping list of the selected group purchase activity stored in the group purchase database. Determine if the registered shopping list of the selected group purchase activity satisfies the discount condition of the selected group purchase activity. The contact information of the selected group purchase activity is transmitted to the client if the registered shopping list of the selected group purchase activity satisfies the discount condition of the selected group purchase activity.

According to another embodiment of this invention, a real-time and localized matching platform for group purchase is provided. The real-time and localized matching platform for group purchase includes a wireless communication unit, a storage unit and a processing unit. The processing unit is electrically connected with the wireless communication unit and the storage unit respectively. The storage unit stores a group purchase database. The group purchase database stores information of several present group purchase activities. The information of the present group purchase activities includes positions, discount conditions, shopping lists and contact information of the present group purchase activities. The processing unit includes a sifting module, a selecting module, a list-processing module and a contact information module. The sifting module receives at least one present location of at least one client through the wireless communication unit, sifts several nearby group purchase activities held near the present position of the client from the present group purchase activities according to the positions of the present group purchase activities and provides the nearby group purchase activities to the client through the wireless communication unit. The selecting module receives a selection message from the client through the wireless communication unit, wherein the selection message includes information of a selected group purchase activity selected from the nearby group purchase activities. The list-processing module obtains the client's shopping list for the selected group purchase activity from the client through the wireless communication unit. The list-processing module registers the client's shopping list to the shopping list of the selected group purchase activity stored in the group purchase database and determines if the registered shopping list of the selected group purchase activity satisfies the discount condition of the selected group purchase activity. If the registered shopping list of the selected group purchase activity satisfies the discount condition of the selected group purchase activity, the contact information module transmits the contact information of the selected group purchase activity to the client through the wireless communication unit.

According to another embodiment of this invention, a real-time and localized matching system for group purchase is provided. The real-time and localized matching system for group purchase includes at least one client and a real-time and localized matching platform for group purchase. The client includes a position-obtaining unit and a first wireless communication unit, which are electrically connected with each other. The position-obtaining unit obtains a present position of the client. The present position of the client is transmitted through the first wireless communication unit. The real-time and localized matching platform for group purchase includes a second wireless communication unit, a storage unit and a processing unit. The storage unit stores a group purchase database. The group purchase database stores information of several present group purchase activities. The information of the present group purchase activities includes positions, discount conditions, shopping lists and contact information of the present group purchase activities. The processing unit includes a sifting module, a selecting module, a list-processing module and a contact information module. The sifting module receives the present location of the client through the second wireless communication unit. The sifting module sifts several nearby group purchase activities held near the present position of the client from the present group purchase activities according to the positions of the present group purchase activities. The sifting module provides the nearby group purchase activities to the client through the second wireless communication unit. The selecting module receives a selection message from the client through the second wireless communication unit, wherein the selection message includes information of a selected group purchase activity selected from the nearby group purchase activities. The list-processing module obtains the client's shopping list for the selected group purchase activity from the first wireless communication unit of the client through the second wireless communication unit. The list-processing module registers the client's shopping list to the shopping list of the selected group purchase activity stored in the group purchase database and determines if the registered shopping list of the selected group purchase activity satisfies the discount condition of the selected group purchase activity. If the registered shopping list of the selected group purchase activity satisfies the discount condition of the selected group purchase activity, the contact information module transmits the contact information of the selected group purchase activity to the first wireless communication unit of the client through the second wireless communication unit.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 illustrates a block diagram of a real-time and localized matching system for group purchase according to one embodiment of this invention;

FIG. 2 is a flow diagram of a real-time and localized matching method for group purchase according to another embodiment of this invention;

FIG. 3 is an embodiment for the client to initiate a new present group purchase activity (step 430) in FIG. 2; and

FIG. 4 is a flow diagram of a real-time and localized matching method for group purchase according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

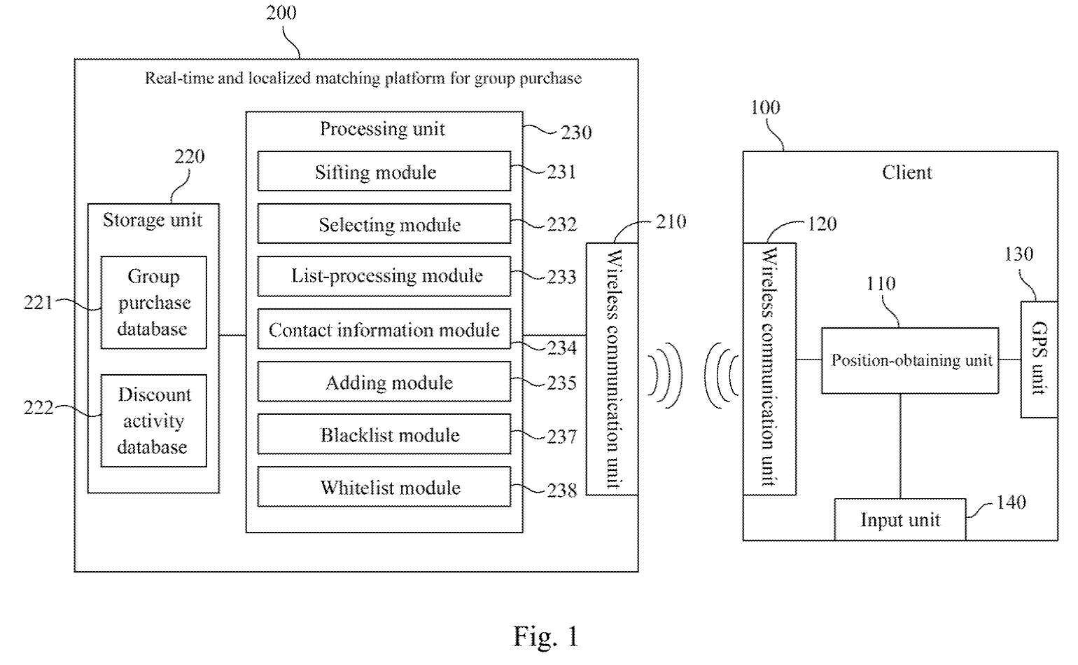

FIG. 1 illustrates a block diagram of a real-time and localized matching system for group purchase according to one embodiment of this invention. The real-time and localized matching system for group purchase includes at least one client 100 and a real-time and localized matching platform for group purchase 200. The real-time and localized matching platform for group purchase 200 provides information of group purchase activities held around the client 100. In addition, the client 100 may initiate another group purchase activity for others nearby to join in.

The client 100 includes a position-obtaining unit 110 and a wireless communication unit 120, which are electrically connected with each other. The position-obtaining unit 110 obtains a present position of the client 100. The present position of the client 100 is transmitted through the wireless communication unit 120. The client 100 may be a mobile phone, a wireless to Personal Digital Assistant (PDA), a laptop or other electrical devices with wireless communication function. The wireless communication unit 120 may utilize 2 G, 3 G, 4 G, Wi-Fi, IEEE 802.11 series, Zigbee, bluetooth or any other wireless communication protocol to transmit or receive data.

The client 100 may further include a Global Positioning System (GPS) unit 130, which is electrically connected with the position-obtaining unit 110. The GPS unit 130 generates the present position of the client 100 according to a GPS signal, such that the position-obtaining unit 110 can obtain the present position of the client 100 from the GPS unit 130. In another embodiment, the client 100 may further include an input unit 140, which is electrically connected with the position-obtaining unit 110. The input unit 140 may be a keyboard, a mouse, a touch panel or other types of input unit. Therefore, the position-obtaining unit 110 can obtain the present position of the client 100, which is input through the input unit 140 by users. In other embodiments, the position-obtaining unit 110 may obtain the present position of the client 100 through other positioning method, which should not be limited in this disclosure.

The real-time and localized matching platform for group purchase 200 includes a wireless communication unit 210, a storage unit 220 and a processing unit 230. The wireless communication unit 210 may build connection with the wireless communication unit 120 of the client 100 through wireless communication protocol, such as 2 G, 3 G, 4 G, Wi-Fi, IEEE 802.11 series, Zigbee, bluetooth or any other wireless communication protocol.

The storage unit 220 stores a group purchase database 221. The group purchase database 221 stores information of several present group purchase activities, which are still taking place. The information of the present group purchase activities includes positions, discount conditions, shopping lists, joined member lists, blacklists, whitelists of the present group purchase activities, contact information of persons who hold the present group purchase activities or any other present group purchase activities related information. The processing unit 230 includes a sifting module 231, a selecting module 232, a list-processing module 233 and a contact information module 234. The sifting module 231 receives the present location of the client 100 from the wireless communication unit 120 through the wireless communication unit 210. The sifting module 231 sifts several nearby group purchase activities held near the present position of the client 100 from the present group purchase activities stored in the group purchase database 221 according to the positions of the present group purchase activities. The sifting module 231 provides the nearby group purchase activities to the client 100 through the wireless communication unit 210. Therefore, users of the client 100 can know the group purchase activities held nearby.

To provide users better shopping experience, the nearby group purchase activities may be further sifted according to blacklists or whitelists. Therefore, the processing unit may further include a blacklist module 237 or a whitelist module 238. In one embodiment, the blacklist module 237 may determine if the client 100 is listed in the blacklists of the nearby group purchase activities. Wherein, the blacklists of the persons who initiate the nearby group purchase activities may be taken as the blacklists of the nearby group purchase activities respectively. If the client 100 is listed in at least one of the blacklists of the nearby group purchase activities, the blacklist module 237 removes at least one group purchase, in blacklist of which the client 100 is listed, from the nearby group purchase activities without providing to the client 100.

In another embodiment, the blacklist module 237 may obtain at least a blacklist member of the client 100 and determine if the blacklist member of the client is listed in the member lists of the nearby group purchase activities. If is the blacklist member of the client 100 is listed in at least one of the member lists of the nearby group purchase activities, the blacklist module 237 removes at least one group purchase activity, in the member list of which the blacklist member of the client is listed, from the nearby group purchase activities without providing to the client 100. Therefore, probability of terrible shopping experiences for the user of the client 100 may be reduced.

In addition, the whitelist module 238 may obtain at least a whitelist member of the client and determines if the whitelist member of the client is listed in the member lists of the nearby group purchase activities. If the whitelist member of the client 100 is listed in at least one of the member lists of the nearby group purchase activities, the whitelist module 238 marks at least one of the nearby group purchase activities, in the member list of which the whitelist member of the client is listed. Wherein, the whitelist module 238 may utilize highlight or other effect for marking. Hence, users of the client 100 can notice that the marked group purchase activity is the preferred choice.

Then, users of the client 100 can select one of the nearby group purchase activities to join. The client 100 generates and transmits a selection message, which includes information of the selected group purchase activity selected from the nearby group purchase activities, to the wireless communication unit 210 through the wireless communication unit 120. The selecting module 232 receives the selection message from the wireless communication unit 120 of the client 100 through the wireless communication unit 210.

The list-processing module 233 obtains the client's shopping list for the selected group purchase activity from the wireless communication unit 120 of the client 100 through the wireless communication unit 210. The list-processing module 233 registers the client's shopping list to the shopping list of the selected group purchase activity stored in the group purchase database 221 and determines if the registered shopping list of the selected group purchase activity satisfies the discount condition of the selected group purchase activity. Wherein, the discount condition of the selected group purchase activity may be a threshold for accumulated pay up amount, a threshold for accumulated number of goods to be purchased or any other discount condition of the selected group purchase activity.

If the registered shopping list of the selected group purchase activity satisfies the discount condition of the selected group purchase activity, the contact information module 234 transmits the contact information of the selected group purchase activity to the wireless communication unit 120 of the client 100 through the wireless communication unit 210. Wherein, the contact information of the selected group purchase activity may include a location for delivery, phone number of the person who initiates the selected group purchase activity or any other contact information of the selected group purchase activity. Therefore, the user of the client 100 can join the selected group purchase activity according to the contact information of the selected group purchase activity. In addition, the contact information of the selected group purchase activity may further include a map marked with the location for delivery, such that the user of the client 100 can go to the location for delivery according to the marked map. Moreover, the contact information module 234 may transmit the contact information of the selected group purchase activity to other members in the joined member lists of the selected group purchase activity.

Besides, the user of the client 100 may initiate another group purchase activity for others nearby to join in. Therefore, the client 100 may transmit adding signal to add (initiate) a new present group purchase activity through the wireless communication unit 120. The processing unit 230 of the real-time and localized matching platform for group purchase 200 may further include an adding module 235 to receive the adding signal. Then, the adding module 235 obtains information of the new present group purchase activity and stores the information of the new present group purchase activity into the group purchase database 221.

Wherein, the adding signal may be generated through the input unit 140. In other words, the user of the client 100 may input the information of the new present group purchase activity to generate the adding signal through the input device 140. In addition, the real-time and localized matching platform for group purchase 200 may provide client 100 information of discount activities held near the client 100, which can be candidates for client 100 to initiate the new present group purchase activity. Therefore, the storage unit 220 may further store a discount activity database 222 storing information of several discount activities. The information of the discount activities includes positions and discount conditions of the discount activities. The adding module 235 sifts several nearby discount activities held near the present position of the client 100 from the discount activities according to the positions of the discount activities, and provides the nearby discount activities to the client 100. Hence, the user of the client 100 can select the new present group purchase activity from the nearby discount activities. Besides, vendors can provide information of their discount activities to be stored in the discount activity database 222. Therefore, the discount activities stored in the discount activity database 222 may be candidates for the user of the client 100 to initiate group purchase activities, which may raise turnover of the vendors.

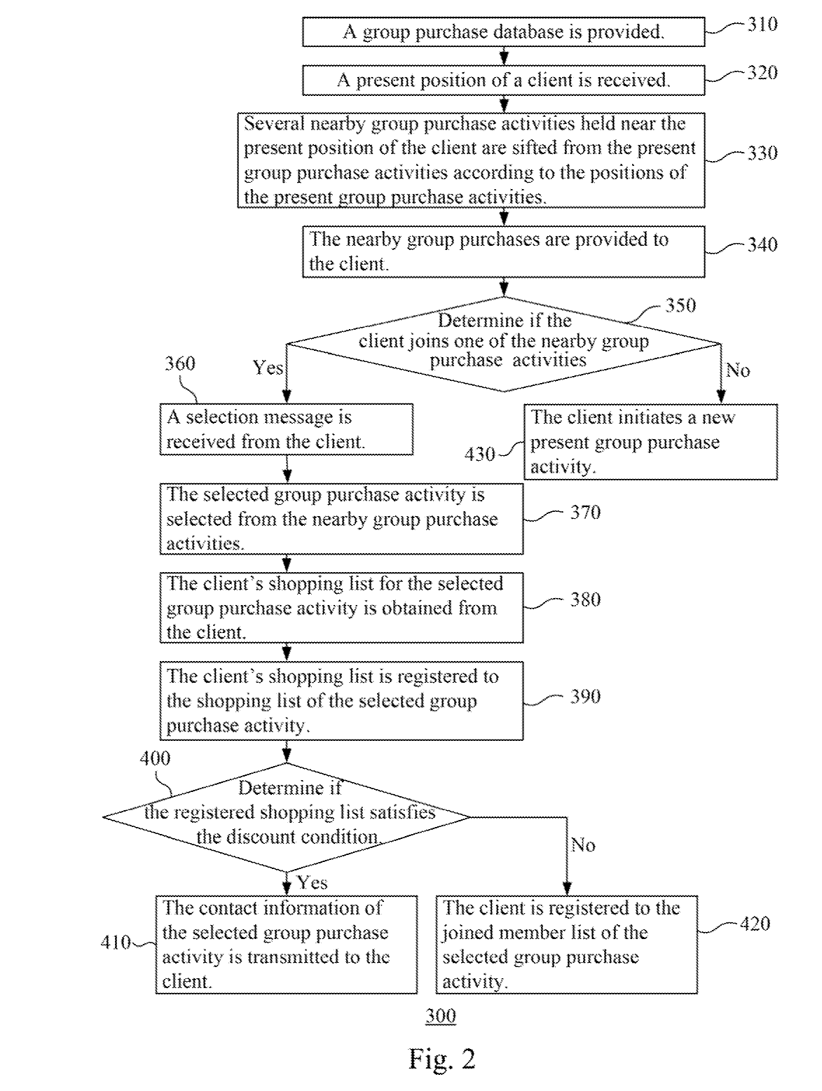

FIG. 2 is a flow diagram of a real-time and localized matching method for group purchase according to another embodiment of this invention. In the real-time and localized matching method for group purchase, group purchase activities held near the position of the client are provided to the client. In addition, the client may initiate another group purchase activities for others nearby to join in. A computer-readable medium may be encoded with a computer program to execute the real-time and localized matching method for group purchase. Some steps of the real-time and localized matching method for group purchase are executed by a real-time and localized matching platform for group purchase, wherein the real-time and localized matching platform for group purchase may be a computer or any other electrical device. The real-time and localized matching method for group purchase 300 includes the following steps:

In step 310, a group purchase database is provided. The group purchase database stores information of several present group purchase activities, which are still taking place. The information of the present group purchase activities includes positions, discount conditions, shopping lists, joined member lists, blacklists, whitelists of the present group purchase activities, contact information of persons who hold the present group purchase activities or any other present group purchase activity related information.

In step 320, a present position of a client is received. The client may obtain its present position through GPS or any other positioning method. In addition, the present position may be obtained through an input device of the client. In other words, the user of the client may input the present position through the input device.

In step 330, several nearby group purchase activities held near the present position of the client are sifted from the present group purchase activities stored in the group purchase database according to the positions of the present group purchase activities.

To provide users better shopping experience, the nearby group purchase activities may be further sifted according to blacklists or whitelists after step 330. Therefore, after step 330, if the client is listed in the blacklists of the nearby group purchase activities may be determined. Wherein, the blacklists of the persons who initiate the nearby group purchase activities may be taken as the blacklists of the nearby group purchase activities respectively. If the client is listed in at least one of the blacklists of the nearby group purchase activities, at least one group purchase activity, in blacklist of which the client 100 is listed, may be removed from the nearby group purchase activities without providing to the client.

In another embodiment, after step 330, at least a blacklist member of the client may be obtained and determine if the blacklist member of the client is listed in the member lists of the nearby group purchase activities. If the blacklist member of the client is listed in at least one of the member lists of the nearby group purchase activities, at least one group purchase activity, in the member list of which the blacklist member of the client is listed, may be removed from the nearby group purchase activities without providing to the client. Therefore, probability of terrible shopping experiences for the user of the client may be reduced.

In addition, after step 330, at least a whitelist member of the client may be obtained and if the whitelist member of the client is listed in the member lists of the nearby group purchase activities may be determined. If the whitelist member of the client listed in at least one of the member lists of the nearby group purchase activities, at least one of the nearby group purchase activities, in the member list of which the whitelist member of the client is listed, may be marked. Wherein, highlight or other effect may be utilized for marking. Hence, users of the client can notice that the marked group purchase activity is the preferred choice.

In step 340, the nearby group purchase activities are provided to the client. Then, the user of the client can join one of the nearby group purchase activities.

In step 350, if the client joins one of the nearby group purchase activities may be determined. In one embodiment, a request to inquire if the client joins one of the nearby group purchase activities may be transmitted to the client for determination of the step 350. In step 430, if the client doesn't join any of the nearby group purchase activities, the client may initiate a new present group purchase activity. In other words, if the user of the client doesn't want to join the nearby group purchase activities provided in step 340, the user of the client can initiate a new present group purchase activity.

In step 360, if the client wants to join one of the nearby group purchase activities, a selection message, which includes information of the selected group purchase activity selected from the nearby group purchase activities, is received from the client. Then, in step 370, the selected group purchase activity is selected from the nearby group purchase activities.

In step 380, the client's shopping list for the selected group purchase activity is obtained from the client.

In step 390, the client's shopping list is registered to the shopping list of the selected group purchase activity stored in the group purchase database.

In step 400, determine if the registered shopping list of the selected group purchase activity satisfies the discount condition of the selected group purchase activity.

In step 410, if the registered shopping list of the selected group purchase activity satisfies the discount condition of the selected group purchase activity, the contact information of the selected group purchase activity is transmitted to the client. Wherein, the contact information of the selected group purchase activity may include a location for delivery, phone number of the person who initiates the selected group purchase activity or any other contact information of the selected group purchase activity. Therefore, the user of the client can join the selected group purchase activity according to the contact information of the selected group purchase activity. In addition, the contact information of the selected group purchase activity may further include a map marked with the location for delivery, such that the user of the client can go to the location for delivery according to the marked map. Moreover, the contact information of the selected group purchase activity may be transmitted to other members in the joined member lists of the selected group purchase activity if the registered shopping list of the selected group purchase activity satisfies the discount condition of the selected group purchase activity.

In step 420, if the registered shopping list of the selected group purchase activity does not satisfy the discount condition of the selected group purchase activity, the client is registered to the joined member list of the selected group purchase activity stored in the group purchase database. Therefore, the client can wait until the discount condition of the selected group purchase activity is satisfied.

In addition, in the real-time and localized matching method for group purchase 300, step 320, step 340, step 360, step 380 and step 410 may be executed through a wireless communication protocol. Therefore, users can take a mobile phone, a wireless PDA, a laptop or other electrical devices with wireless communication function as the client for joining localized group purchase activities real-time.

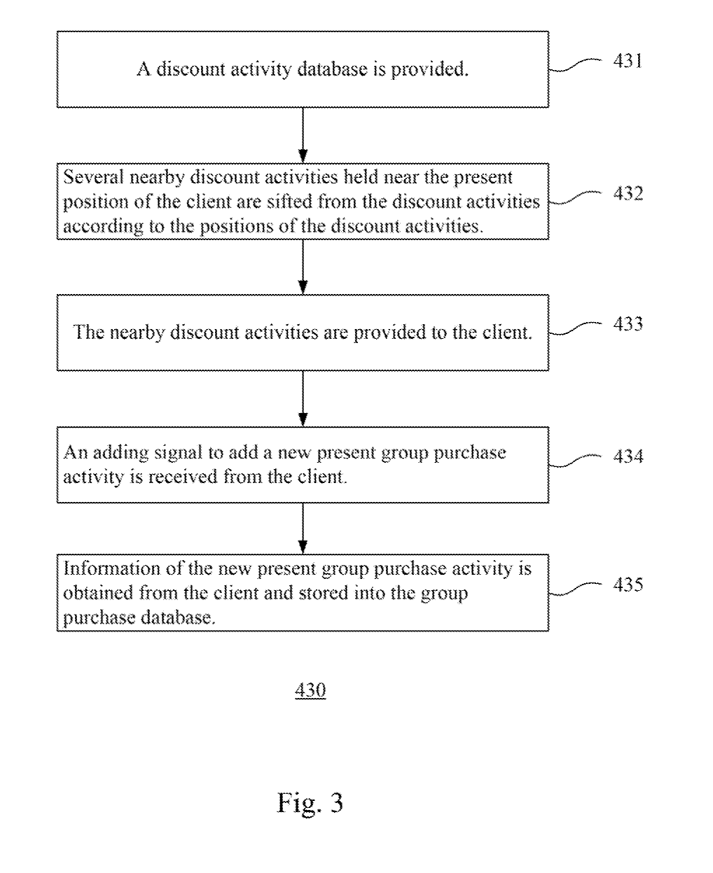

FIG. 3 is an embodiment for the client to initiate a new present group purchase activity (step 430) in FIG. 2. The step for the client to initiate a new present group purchase activity (step 430) includes the following steps:

In step 431, a discount activity database is provided. The discount activity database stores information of several discount activities. The information of the discount activities includes positions, discount conditions of the discount activities or any other discount activity related information.

In step 432, several nearby discount activities held near the present position of the client are sifted from the discount activities stored in the discount activity database according to the positions of the discount activities.

In step 433, the nearby discount activities are provided to the client. Hence, the user of the client can select a new present group purchase activity from the nearby discount activities to make the client generate an adding signal to add (initiate) the new present group purchase activity.

In step 434, the adding signal to add (initiate) the new present group purchase activity is received from the client.

In step 435, information of the new present group purchase activity is obtained from the client and stored into the group purchase database. Therefore, the discount activities stored in the discount activity database may be candidates for the user of the client to initiate group purchase activities. Besides, vendors can provide information of their discount activities to be stored in the discount activity database, which may raise turnover of the vendors.

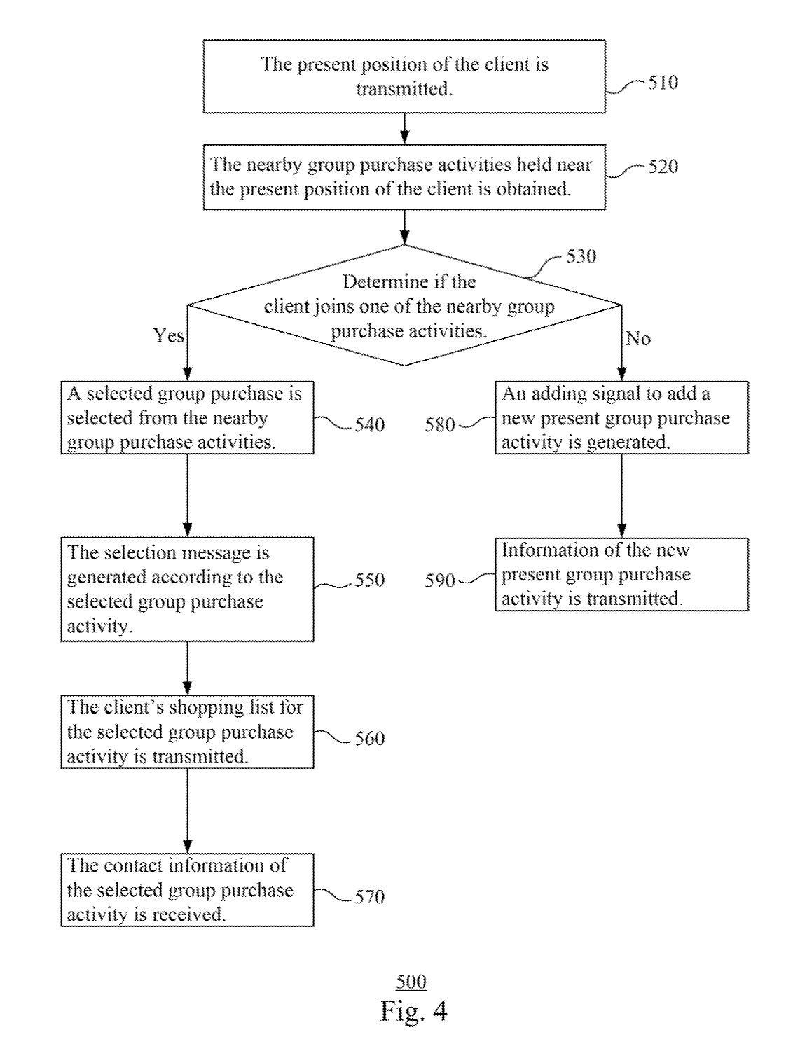

FIG. 4 is a flow diagram of a real-time and localized matching method for group purchase according to another embodiment of this invention. In the real-time and localized matching method for group purchase, a client transmits its present position to obtain group purchase activities held nearby. In addition, the client may initiate another group purchase activity for others nearby to join in. A computer-readable medium may be encoded with a computer program to execute the real-time and localized matching method for group purchase. Some steps of the real-time and localized matching method for group purchase is executed by a client, wherein a mobile phone, a wireless PDA, a laptop or other electrical devices with wireless communication function may be utilized as the client thereof. The real-time and localized matching method for group purchase 500 includes the following steps:

The present position of the client is transmitted (step 510) to obtain the nearby group purchase activities held near the present position of the client (step 520). Wherein, the present position of the client may be generated through GPS or any other positioning method. In addition, the present position of the client may be obtained through an input device of the client. In other words, the user of the client may input the present position through the input device. Besides, transmission in step 510 may be executed through a wireless communication protocol, such as 2 G, 3 G, 3.5 G, 4 G, Wi-Fi, IEEE 802.11 series, Zigbee, bluetooth or any other wireless communication protocol.

In step 530, determine if the client joins one of the nearby group purchase activities. In one embodiment, a request to inquire if the client joins one of the nearby group purchase activities may be provided to the client for determination of the step 530.

In step 540, if the client wants to join one of the nearby group purchase activities, a selected group purchase activity is selected from the nearby group purchase activities.

In step 550, the selection message is generated according to the selected group purchase activity.

In step 560, the client's shopping list for the selected group purchase activity is transmitted. If the discount condition of the selected group purchase activity is satisfied, the contact information of the selected group purchase activity may be received (step 570).

In step 580, if the client doesn't want to join any of the nearby group purchase activities, an adding signal to add (initiate) a new present group purchase activity is generated. In step 590, information of the new present purchase is transmitted to be stored into a group purchase database. Wherein, several nearby discount activities held near the present position of the client may be received to be the candidate for the new present purchase initiated by the client.

Above all, consumers can utilize an electrical device with wireless communication protocol to join a localized group purchase activity held nearby real-time for discount. In addition, consumers can raise a new group purchase activity to find others nearby, which are interested in the same discount activity. Besides, since group purchase activities, which may be joined by the user of the client, are held near the client, users of the client can obtain the goods they want once the discount condition is satisfied. Several consumers, which are interested in the same discount activity, can be gathered without knowing each other after matched. Vendors can provide information of their discount activities to be candidate for group purchase activity, which may raise turnover of the vendors.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A real-time and localized matching method for group purchase, wherein steps of the real-time and localized matching method for group purchase executed by a real-time and localized matching platform for group purchase comprises:
providing a group purchase database, wherein the group purchase database stores information of a plurality of present group purchase activities, the information of the present group purchase activities comprises positions, discount conditions, shopping lists and contact information of the present group purchase activities;
receiving a present position of a client;
sifting a plurality of nearby group purchase activities held near the present position of the client from the present group purchase activities according to the positions of the present group purchase activities;
providing the nearby group purchase activities to the client;
receiving a selection message from the client, wherein the selection message comprises information of a selected group purchase activity selected from the nearby group purchase activities;
obtaining the client's shopping list for the selected group purchase activity from the client;
registering the client's shopping list to the shopping list of the selected group purchase activity stored in the group purchase database;
determining if the registered shopping list of the selected group purchase activity satisfies the discount condition of the selected group purchase activity; and
transmitting the contact information of the selected group purchase activity to the client if the registered shopping list of the selected group purchase activity satisfies the discount condition of the selected group purchase.

2. The real-time and localized matching method for group purchase of to claim 1, wherein steps of the real-time and localized matching method for group purchase executed by the real-time and localized matching platform for group purchase further comprises:
receiving an adding signal to add a new present group purchase activity from the client;
is obtaining information of the new present group purchase activity from the client; and
storing the information of the new present group purchase activity into the group purchase database.

3. The real-time and localized matching method for group purchase of claim 2, wherein steps of the real-time and localized matching method for group purchase executed by the real-time and localized matching platform for group purchase further comprises:
providing a discount activity database, wherein the discount activity database stores information of a plurality of discount activities, the information of the discount activities includes positions and discount conditions of the discount activities;
sifting a plurality of nearby discount activities held near the present position of the client from the discount activities according to the positions of the discount activities; and
providing the nearby discount activities to the client, such that the client selects the new present group purchase activity from the nearby discount activities.

4. The real-time and localized matching method for group purchase of claim 1, wherein the information of the present group purchase activities further comprises blacklists of the present group purchase activities, and steps of the real-time and localized matching method for group purchase executed by the real-time and localized matching platform for group purchase further comprises:
determining if the client is listed in the blacklists of the nearby group purchase activities; and
if the client is listed in at least one of the blacklists of the nearby group purchase activities, removing at least one group purchase activity, in blacklist of which the client is listed, from the nearby group purchase activities.

5. The real-time and localized matching method for group purchase of claim 1, wherein the information of the present group purchase activities further comprises member lists of the present group purchase activities, and steps of the real-time and localized matching method for group purchase executed by the real-time and localized matching platform for group purchase further comprises:
obtaining at least a blacklist member of the client;
determining if the blacklist member of the client is listed in the member lists of the nearby group purchase activities; and
if the blacklist member of the client is listed in at least one of the member lists of the nearby group purchase activities, removing at least one group purchase activity, in the member list of which the blacklist member of the client is listed, from the nearby group purchase activities.

6. The real-time and localized matching method for group purchase of claim 1, wherein the information of the present group purchase activities further comprises member lists of the present group purchase activities, and steps of the real-time and localized matching method for group purchase executed by the real-time and localized matching platform for group purchase further comprises:
obtaining at least a whitelist member of the client;
determining if the whitelist member of the client is listed in the member lists of the nearby group purchase activities; and
if the whitelist member of the client is listed in at least one of the member lists of the nearby group purchase activities, marking at least one of the nearby group purchase activities, in the member list of which the whitelist member of the client is listed.

7. The real-time and localized matching method for group purchase of claim 1, wherein steps of receiving the present position of the client, providing the nearby group purchase activities to the client, obtaining the client's shopping list and transmitting the contact information of the selected group purchase activity are executed through a wireless communication protocol.

8. The real-time and localized matching method for group purchase of claim 1, wherein steps of the real-time and localized matching method for group purchase executed by the client comprises:
transmitting the present position of the client to obtain the nearby group purchase activities held near the present position of the client;
selecting the selected group purchase activity from the nearby group purchase activities;
generating the selection message according to the selected group purchase activity and transmitting the selection message; and
receiving the contact information of the selected group purchase activity.

9. The real-time and localized matching method for group purchase of claim 8, wherein steps of the real-time and localized matching method for group purchase executed by the client further comprises:
generating an adding signal to add a new present group purchase activity; and
transmitting information of the new present group purchase activity.

10. The real-time and localized matching method for group purchase of claim 9, wherein steps of the real-time and localized matching method for group purchase executed by the client further comprises:
receiving a plurality of nearby discount activities held near the present position of the client; and
selecting the new present group purchase activity from the nearby discount activities.

11. The real-time and localized matching method for group purchase of claim 8, wherein steps of the real-time and localized matching method for group purchase executed by the client further comprises:
obtaining the present position of the client utilizing a Global Positioning System (GPS).

12. The real-time and localized matching method for group purchase of claim 8, wherein the client comprise an input device, and steps of the real-time and localized matching method for group purchase executed by the client further comprises:
obtaining the present position of the client input through the input device.

13. A real-time and localized matching platform for group purchase, comprises:
a wireless communication unit;
a storage unit, storing a group purchase database, wherein the group purchase database stores information of a plurality of present group purchase activities, the information of the present group purchase activities comprises positions, discount conditions, shopping lists and contact information of the present group purchase activities; and
a processing unit, electrically connected with the wireless communication unit and the storage unit, comprising:
a sifting module, receiving at least one present location of at least one client through the wireless communication unit, sifting a plurality of nearby group purchase activities held near the present position of the client from the present group purchase activities according to the positions of the present group purchase activities and providing the nearby group purchase activities to the client through the wireless communication unit;
a selecting module, receiving a selection message from the client through the wireless communication unit, wherein the selection message comprises information of a selected group purchase activity selected from the nearby group purchase activities;
a list-processing module, obtaining the client's shopping list for the selected group purchase activity from the client through the wireless communication unit, registering the client's shopping list to the shopping list of the selected group purchase activity stored in the group purchase database and determining if the registered shopping list of the selected group purchase activity satisfies the discount condition of the selected group purchase activity; and
a contact information module, transmitting the contact information of the selected group purchase activity to the client through the wireless communication unit if the registered shopping list of the selected group purchase activity satisfies the discount condition of the selected group purchase activity.

14. The real-time and localized matching platform for group purchase of claim 13, wherein the processing unit further comprising:
an adding module, receiving an adding signal to add a new present group purchase activity, obtaining information of the new present group purchase activity and storing the information of the new present group purchase activity into the group purchase database.

15. The real-time and localized matching platform for group purchase of claim 14, wherein the storage unit further stores:
a discount activity database, storing information of a plurality of discount activities, wherein the information of the discount activities includes positions and discount conditions of the discount activities,
wherein the adding module sifts a plurality of nearby discount activities held near the present position of the client from the discount activities according to the positions of the discount activities, and provides the nearby discount activities to the client, such that the client selects the new present group purchase activity from the nearby discount activities.

16. The real-time and localized matching platform for group purchase of claim 13, wherein the information of the present group purchase activities further comprises blacklists of the present group purchase activities, and the processing unit further comprises:
a blacklist module, determining if the client is listed in the blacklists of the nearby group purchase activities,
wherein the blacklist module removes at least one group purchase, in blacklist of which the client is listed, from the nearby group purchase activities if the client is listed in at least one of the blacklists of the nearby group purchase activities.

17. The real-time and localized matching platform for group purchase of claim 13, wherein the information of the present group purchase activities further comprises member lists of the present group purchase activities, and the processing unit further comprises:
a blacklist module, obtaining at least a blacklist member of the client and determining if the blacklist member of the client is listed in the member lists of the nearby group purchase activities,
wherein the blacklist module removes at least one group purchase activity, in the member list of which the blacklist member of the client is listed, from the nearby group purchase activities if the blacklist member of the client is listed in at least one of the member lists of the nearby group purchase activities.

18. The real-time and localized matching platform for group purchase of claim 13, wherein the information of the present group purchase activities further comprises member lists of the present group purchase activities, and the processing unit further comprises:
a whitelist module, obtaining at least a whitelist member of the client and determining if the whitelist member of the client is listed in the member lists of the nearby group purchase activities,
wherein the whitelist module marks at least one of the nearby group purchase activities, in the member list of which the whitelist member of the client is listed, if the whitelist member of the client is listed in at least one of the member lists of the nearby group purchase activities.

19. A real-time and localized matching system for group purchase, comprising:
at least one client, comprising:
a position-obtaining unit, obtaining a present position of the client; and
a first wireless communication unit, electrically connected with the position-obtaining unit, wherein the present position of the client is transmitted through the first wireless communication unit; and
a real-time and localized matching platform for group purchase, comprising:
a second wireless communication unit;
a storage unit, storing a group purchase database, wherein the group purchase database stores information of a plurality of present group purchase activities, the information of the present group purchase activities comprises positions, discount conditions, shopping lists and contact information of the present group purchase activities; and
a processing unit, electrically connected with the second wireless communication unit and the storage unit, comprising:
a sifting module, receiving the present location of the client through the second wireless communication unit, sifting a plurality of nearby group purchase activities held near the present position of the client from the present group purchase activities according to the positions of the present group purchase activities and providing the nearby group purchase activities to the client through the second wireless communication unit;
a selecting module, receiving a selection message from the client through the second wireless communication unit, wherein the selection message comprises information of a selected group purchase activity selected from the nearby group purchase activities;
a list-processing module, obtaining the client's shopping list for the selected group purchase activity from the first wireless communication unit of the client through the second wireless communication unit, registering the client's shopping list to the shopping list of the selected group purchase activity stored in the group purchase database and determining if the registered shopping list of the selected group purchase activity satisfies the discount condition of the selected group purchase activity; and
a contact information module, transmitting the contact information of the selected group purchase activity to the first wireless communication unit of the client through the second wireless communication unit if the registered shopping list of the selected group purchase activity satisfies the discount condition of the selected group purchase activity.

20. The real-time and localized matching system for group purchase of claim 19, wherein the client further comprises:
a GPS unit, electrically connected with the position-obtaining unit, generating the present position of the client according to a GPS signal.

21. The real-time and localized matching system for group purchase of claim 19, wherein the client further comprises:
an input unit, electrically connected with the position-obtaining unit, wherein the present position of the client is input through the input unit.
